(19) United States
(12) Patent Application Publication
(10) Pub. No.: US 2020/0306765 A1
(43) Pub. Date: Oct. 1, 2020

(54) DRUM TYPE SEPARATION APPARATUS

(71) Applicant: SUMITOMO HEAVY INDUSTRIES FINETECH, LTD., Okayama (JP)

(72) Inventor: Shinya Nishizawa, Okayama (JP)

(21) Appl. No.: 16/797,723

(22) Filed: Feb. 21, 2020

(30) Foreign Application Priority Data
Mar. 29, 2019 (JP) 2019-065536

(51) Int. Cl. B03C 1/12

(52) U.S. Cl. CPC B03C 1/12; B03C 1/284; B03C 2201/20; B03C 2201/18

(57) ABSTRACT

A drum type separation apparatus includes a liquid passage that allows a liquid mixed with a magnetic body to pass therethrough, a rotary drum that is disposed such that a part of the rotary drum is exposed above a liquid surface in the liquid passage, and transports the magnetic body adsorbed on an outer peripheral surface as the rotary drum rotates, and a magnet that is disposed on an inner side of the rotary drum, in which a magnetic force on a side lower than the liquid surface from an intersection position where the rotary drum and the liquid surface intersect each other is larger than a magnetic force on a side higher than the liquid surface from the intersection position.

### RELATED APPLICATIONS

The content of Japanese Patent Application No. 2019-065536, on the basis of which priority benefits are claimed in an accompanying application data sheet, is in its entirety incorporated herein by reference.

### BACKGROUND

### Technical Field

A certain embodiment of the present invention relates to a drum type separation apparatus.

### Description of Related Art

During metal working in which a machine tool such as a grinder is used, magnetic bodies such as metal pieces are generated from a work material. In the related art, there is a drum type separation apparatus that introduces a coolant liquid including such magnetic bodies and collects the magnetic bodies from the coolant liquid. The drum type separation apparatus includes a rotary drum that is disposed such that a part thereof is immersed in a coolant liquid, a magnet that is on an inner side of the rotary drum and pulls the magnetic bodies to the rotary drum, and a scraper that scrapes the magnetic bodies transported by the rotary drum from an outer peripheral surface.

In the drum type separation apparatus configured as described above, a capacity of the rotary drum transporting the magnetic bodies changes according to disposition and strength of the magnet. It is desirable for the drum type separation apparatus to reduce apparatus costs while maintaining the capacity of transporting the magnetic bodies, leaving a room for improvement for this point.

### SUMMARY

According to an aspect of the present invention, there is provided a drum type separation apparatus including a liquid passage that allows a liquid mixed with a magnetic body to pass therethrough, a rotary drum that is disposed such that a part of the rotary drum is exposed above a liquid surface in the liquid passage, and transports the magnetic body adsorbed on an outer peripheral surface as the rotary drum rotates, and a magnet that is disposed on an inner side of the rotary drum. A configuration in which a magnetic force on a side lower than the liquid surface from an intersection position where the rotary drum and the liquid surface intersect each other is larger than a magnetic force on a side higher than the liquid surface from the intersection position is adopted.

### BRIEF DESCRIPTION OF THE DRAWINGS

FIG. 1 is a view illustrating a drum type separation apparatus according to an embodiment of the present invention.

FIG. 2 is a view illustrating an example of disposition of permanent magnets.

FIG. 3 is a view illustrating details of the disposition of the permanent magnets.

FIG. 4 is a view illustrating a disposition relationship among a rotary drum, a squeezing roller, and magnets.

FIG. 5 is a view illustrating a modification example of permanent magnets in a drum.

### DETAILED DESCRIPTION

It is desirable to reduce apparatus costs while maintaining a capacity of transporting magnetic bodies in a liquid in a drum type separation apparatus.

According to the present invention, apparatus cost reduction can be achieved while a capacity of transporting the magnetic body in the liquid is maintained.

Hereinafter, an embodiment of the present invention will be described in detail with reference to the drawings.

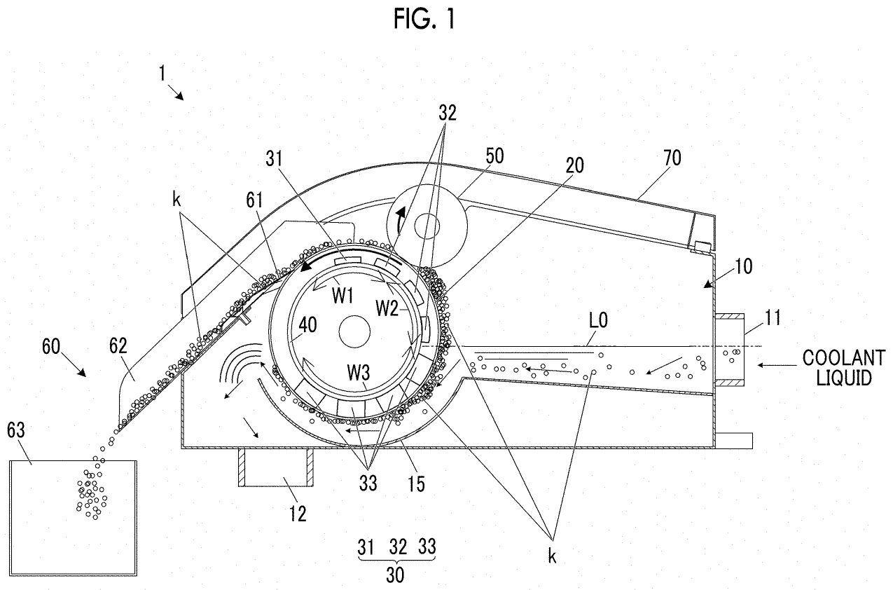

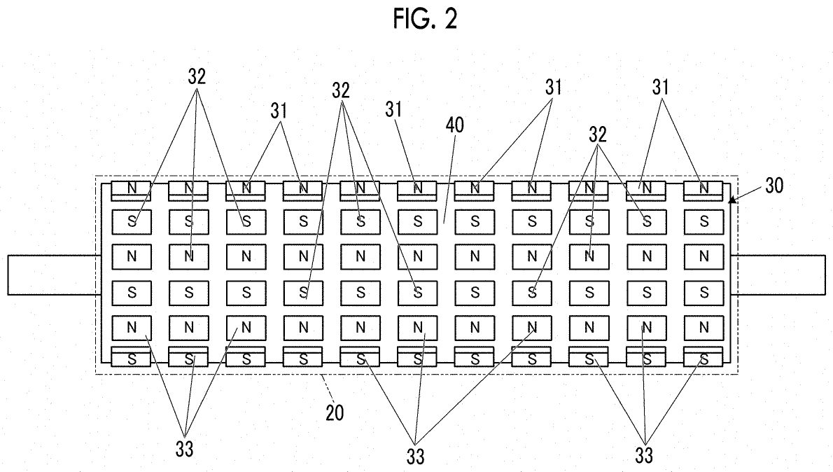

FIG. 1 is a view illustrating a drum type separation apparatus according to the embodiment of the present invention. FIG. 2 is a view illustrating an example of disposition of permanent magnets. In the present specification, when simply referring to a circumferential direction, an axial direction, and a radial direction, the directions mean a circumferential direction, an axial direction, and a radial direction of a rotary drum 20 respectively.

The drum type separation apparatus 1 of the embodiment has a liquid passage 10 that allows a coolant liquid sent from a machine tool to flow therein, the rotary drum 20 that adsorbs magnetic bodies k such as metal pieces onto an outer peripheral surface thereof to transport the magnetic bodies, a magnet 30 disposed along the outer peripheral surface of the rotary drum 20 inside the rotary drum 20, a support body 40 that supports the magnet 30, a squeezing roller 50 that separates out the coolant liquid with the magnetic bodies k interposed between the rotary drum 20 and the squeezing roller, a recovery portion 60 that scrapes and collects the magnetic bodies k transported by the rotary drum 20 from the rotary drum 20, a housing 70 that accommodates the configuration elements of the drum type separation apparatus, a motor (not illustrated) that rotates the rotary drum 20, and an adjusting mechanism (not illustrated) that is capable of adjusting a gap size or a contact pressure between the squeezing roller 50 and the rotary drum 20.

The liquid passage 10 runs in a horizontal direction, has an inlet 11, into which the coolant liquid is introduced, on one side, and has an outlet 12 from which the coolant liquid flows out, on the other side. Aside close to the inlet 11 will be called an upstream side, and a side close to the outlet 12 will be called a downstream side. The liquid passage 10 has a flow path frame 15 of which a sectional shape is an arc shape along the outer peripheral surface of the rotary drum 20 (the section is a longitudinal section along a coolant liquid flowing direction). The flow path frame 15 is disposed below the rotary drum 20. A liquid surface L0 is set in the liquid passage 10 such that a passage upper end is not immersed in the coolant liquid.

The rotary drum 20 is disposed in the liquid passage 10 such that a part thereof is exposed above the liquid surface L0. A rotation center axis of the rotary drum 20 faces the horizontal direction. The rotary drum 20 is rotated by the motor. The rotation direction is a direction where an upstream outer peripheral surface rotates upward and a downstream outer peripheral surface rotates downward.

At a position higher than the liquid surface L0, the squeezing roller 50 is in contact with or approaches the rotary drum 20, and is rotatably disposed. A rotation center axis of the squeezing roller 50 is parallel to the rotation center axis of the rotary drum 20.

The recovery portion 60 includes a scraper 61 that scrapes the magnetic bodies k from the rotary drum 20 at a position higher than the liquid surface L0 and a chute 62 that sends the scraped magnetic bodies k to a collection box 63. A tip part of the scraper 61 is disposed to be in contact with or to approach the outer peripheral surface of the rotary drum 20 above and on a downstream side of the rotation center axis of the rotary drum 20.

The support body 40 has a cylindrical shape along the outer peripheral surface of the rotary drum 20, and is fixed to an inner side of the rotary drum 20.

The magnet 30 includes three groups of permanent magnets 31, 32, and 33 having different magnetic forces from each other. As illustrated in FIGS. 1 and 2, the plurality of magnets 30 are arrayed, for example, at intervals in the circumferential direction and the axial direction, and are disposed toward magnetic poles in the radial direction. The magnetic poles are arranged such that the N-pole and the S-pole alternate in turn along the circumferential direction. The three groups of the permanent magnets 31, 32, and 33 are magnets made of the same material, and have almost the same area seen in the radial direction. As the three groups of the permanent magnets 31, 32, and 33 have thicknesses different from each other, magnetic forces are different from each other. That is, out of the magnets 30, the permanent magnets 31 which have the smallest magnetic force have the smallest thickness. The permanent magnets 32 which have the second smallest magnetic force have the second smallest thickness. The permanent magnets 33 which have the largest magnetic force have the largest thickness.

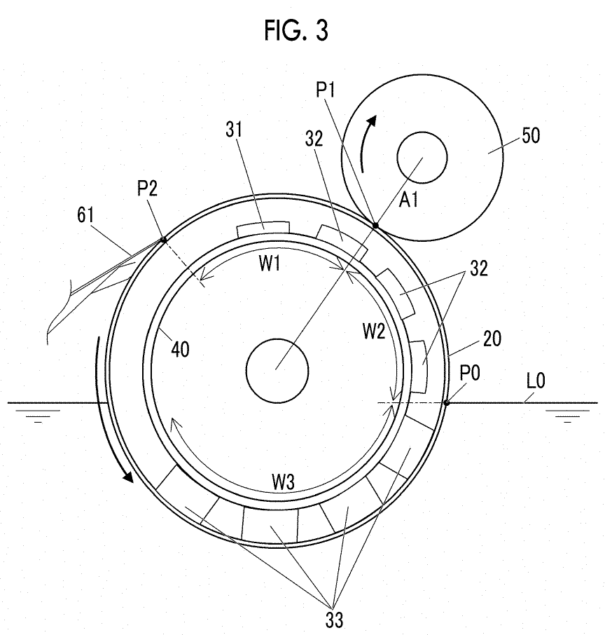

FIG. 3 is a view illustrating details of the disposition of the permanent magnets.

Herein, the disposition of the three groups of the permanent magnets 31, 32, and 33 will be described with the use of angle ranges in the rotation direction of the rotary drum 20 when seen in the axial direction. The permanent magnets 31 which have the smallest magnetic force are disposed in an angle range W1 from a position P1 where the squeezing roller 50 faces the rotary drum 20 to a tip position P2 of the scraper 61. The permanent magnets 32 which have the second largest magnetic force are disposed in an angle range W2 from an intersection position P0 between the rotary drum 20 and the liquid surface L0 on an upstream side to the position P1 facing the squeezing roller 50. It is sufficient that some of the permanent magnets 32 overlap the angle range W2 on a squeezing roller 50 side. The permanent magnets 33 which have the largest magnetic force are disposed in an angle range W3 from the intersection position P0 between the rotary drum 20 and the liquid surface L0 on the upstream side to a transportation section lower than the liquid surface L0. The permanent magnets 31, 32, and 33 have different distances up to the outer peripheral surface of the rotary drum 20 as the permanent magnets have different thicknesses. The permanent magnets 31 have the largest distance, and the permanent magnets 33 have the smallest distance. The angle range W2 corresponds to an example of a first angle range according to the present invention, and the angle range W3 corresponds to an example of a second angle range according to the present invention.

### Operation

Next, operation of the drum type separation apparatus 1 will be described. Ina state where the rotary drum 20 is rotated, the coolant liquid flows in the liquid passage 10 in the drum type separation apparatus 1. When the coolant liquid passes between the rotary drum 20 and the flow path frame 15, the magnetic bodies k included in the coolant liquid are pulled to the magnet 30 (permanent magnets 33) and are adsorbed onto the outer peripheral surface of the rotary drum 20. Since the permanent magnets 33 disposed in the angle range W3 generate a strong magnetic force, the magnetic bodies k can be adsorbed onto the rotary drum 20 against the flow of the coolant liquid.

The adsorbed magnetic bodies k are transported by the rotation of the rotary drum 20, and are moved above the liquid surface L0. Due to a difference between the permanent magnets 33 in the angle range W3 (below the liquid surface L0) and the permanent magnets 32 in the angle range W2 (above the liquid surface L0), a magnetic force of an upper section is weaker than a magnetic force of a lower section with the liquid surface L0 as a boundary. It is necessary to pull the magnetic bodies k against a resistance force of the coolant liquid below the liquid surface L0, and a large magnetic force that makes the pulling possible is set. A magnetic force against the resistance force of the coolant liquid is not necessary above the liquid surface L0, and a magnetic force that allows transportation of the adsorbed magnetic bodies k to a place of the squeezing roller 50 is sufficient. For this reason, by making a magnetic force above the liquid surface L0 smaller than a magnetic force below the liquid surface L0, a capacity of transporting the magnetic bodies k can be maintained while costs can be reduced by the amount that the magnetic force is weakened.

After then, as the magnetic bodies k that are adsorbed on the rotary drum 20 and have exceeded the liquid surface L0 reach between the rotary drum 20 and the squeezing roller 50, a large amount of coolant liquid attached to the magnetic bodies k is separated out. With the magnetic bodies k adsorbed onto the rotary drum 20, the magnetic bodies are transported from a position of the squeezing roller 50 to a position of the scraper 61. Then, the magnetic bodies k are scraped and collected from the rotary drum 20 by the scraper 61.

While moving from the squeezing roller 50 to the position of the scraper 61, the magnetic bodies k move from the angle range W2 where the permanent magnets 32 having a medium magnetic force are disposed to the angle range W1 where the permanent magnets 31 having a small magnetic force are disposed. The magnetic bodies k move from the angle range W1 where the permanent magnets 31 are disposed to a side of the scraper 61 where a permanent magnet is not disposed. In this manner, when moving from a position where a magnetic force is strong to a position where a magnetic force is weak, the magnetic bodies k are adsorbed by the strong magnetic force, and the magnetic bodies k accumulate on a side where the magnetic force is strong in some cases without the magnetic bodies k going to a side where the magnetic force is weak in a case where a difference between the magnetic forces is large.

However, in the embodiment, the permanent magnets 32 disposed in the angle range W2 above the liquid surface L0 are set to have a magnetic force smaller than the permanent magnets 33 in the angle range W3, which are necessary to strongly pull the magnetic bodies k in the coolant liquid. Therefore, a magnetic force difference between the permanent magnets 32 in a place exceeding the squeezing roller 50 and the permanent magnets 31 at a position close to the scraper 61 can be made small. For this reason, in an angle range where the squeezing roller 50 is exceeded and scraping is performed by the scraper 61, a magnetic force difference does not become abrupt. Accordingly, stagnation of the magnetic bodies k caused by the accumulation of the magnetic bodies k can be suppressed. As a result, the magnetic bodies k are efficiently collected.

### MODIFICATION EXAMPLE

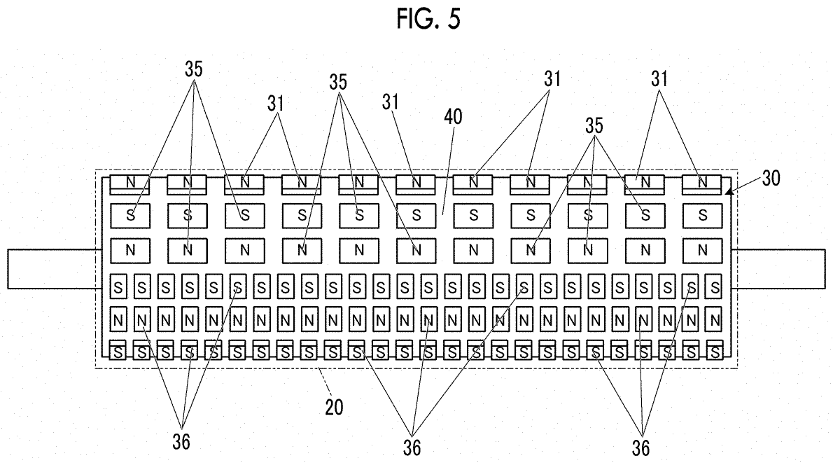

FIG. 5 is a view illustrating a modification example of permanent magnets in the drum.

In the embodiment described above, in order to make the magnitude of a magnetic force exerted from the magnet 30 to the outer peripheral surface of the rotary drum 20 different for each of the angle ranges W1 to W3, thicknesses of the permanent magnets 31, 32, and 33 disposed in the angle ranges W1 to W3 are made different from each other. However, means for making the magnitudes of magnetic forces different from each other are not limited thereto. For example, by making materials for the permanent magnets (for example, ferrite and neodymium) different from each other, the magnitudes of the magnetic forces may be made different from each other. In addition, by making the magnetic forces of the respective permanent magnets the same and making distances between the permanent magnets and the outer peripheral surface of the rotary drum 20 different from each other, the magnitudes of the magnetic forces may be made different from each other.

The permanent magnet has a characteristic that the magnetic flux density of a center portion decreases when the permanent magnet has a large surface area. Therefore, as illustrated with permanent magnets 35 and 36 of FIG. 5, by making an area seen from the radial direction, a disposed number per unit area, and the thickness different, the magnitude of a magnetic force exerted to the outer peripheral surface of the rotary drum 20 may be made different for each angle range. In this case, the permanent magnets 36, each of which has a small area seen from the radial direction, which have a large disposed number per unit area, and each of which has a large thickness, may be disposed in the angle range W3 (FIG. 3), and the permanent magnets 35, each of which has a large area seen from the radial direction, which have a small disposed number per unit area, and each of which has a small thickness, may be disposed in the angle range W2. The permanent magnets 36, each of which has a small area seen from the radial direction, which have a large disposed number per unit area, and each of which has a large thickness, can exert a large magnetic force to the outer peripheral surface of the rotary drum 20. In addition, out of the means for making the magnitudes of magnetic forces different from each other, two or more means may be used in combination.

As described above, in the drum type separation apparatus 1 of the embodiment, a magnetic force exerted from the magnet 30 to the outer peripheral surface of the rotary drum 20 is larger below the intersection position P0 than above the intersection position P0 between the rotary drum and the liquid surface. That is, a magnetic force above the liquid surface L0 which does not need a magnetic force against the resistance force of the coolant liquid is set to be small while a large magnetic force below the liquid surface L0 which is necessary to pull the magnetic bodies k against the resistance force of the coolant liquid is maintained. Therefore, costs of the drum type separation apparatus 1 (costs of apparatus, including component costs) can be reduced by the amount that a magnetic force above the liquid surface L0 is weakened while a capacity of transporting the magnetic bodies k is maintained.

In the drum type separation apparatus 1 of the embodiment, an angle range where a magnetic force smaller than the magnetic force below the liquid surface L0 is exerted is the angle range W2 from the intersection position P0 between the rotary drum 20 and the liquid surface L0 to the position P1 facing the squeezing roller 50. As such a magnetic force in the angle range W2 is made smaller than a magnetic force in the angle range W3 below the liquid surface L0, the detachment of the magnetic bodies k from the outer peripheral surface of the rotary drum 20 can be suppressed from around a time when exceeding the liquid surface L0 to a time when the coolant liquid is separated out by the squeezing roller 50.

In the drum type separation apparatus 1 of the embodiment, a thickness of each of the permanent magnets 32 disposed in the angle range W2 is smaller than a thickness of each of the permanent magnets 33 disposed in the angle range W3. Accordingly, the difference in magnetic force described above can be generated, and a magnetic force exerted to the outer peripheral surface of the rotary drum 20 can be easily adjusted to a design value by using the difference in thickness.

In addition, as described in the modification example of the embodiment, even when materials for the permanent magnets disposed in the angle range W2 and the permanent magnets disposed in the angle range W3 are made different from each other, the difference in magnetic force described above can be generated. In addition, as described in the modification example of the embodiment, the difference in magnetic force described above can be generated by making the permanent magnets 35 and 36 different from each other in terms of an area seen from the radial direction, a disposed number per unit area, and a thickness.

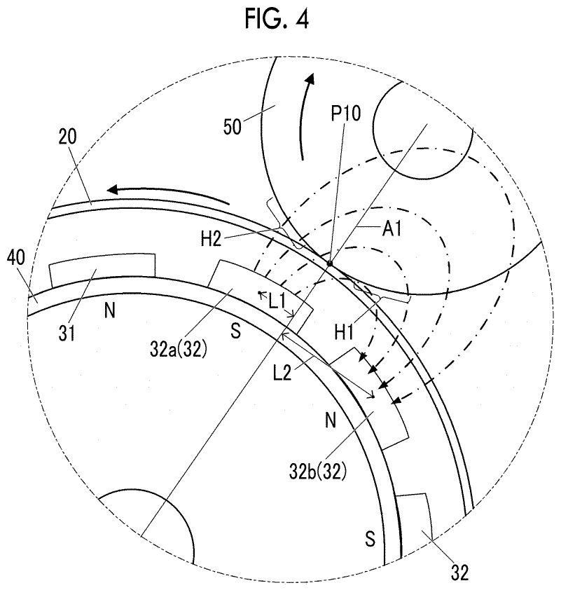

FIG. 4 is a view illustrating a disposition relationship among the rotary drum, the squeezing roller, and the magnets. In FIG. 4, the magnetic flux of each of magnets 32a and 32b is shown with a one-dot chain line.

In a longitudinal section perpendicular to the axial direction, a pair of magnets 32a and 32b, which are disposed close to the squeezing roller 50 and are adjacent to each other, are disposed to be shifted from a line segment A1 that connects the rotation center axis of the rotary drum 20 and the rotation center axis of the squeezing roller 50 to each other. One magnet 32a is disposed to be shifted in the rotation direction of the rotary drum 20 from the line segment A1, and the other magnet 32b is disposed to be shifted in a reverse rotation direction of the rotary drum 20 from the line segment A1. The line segment A1 is shifted in the rotation direction from a midpoint of a line segment that connects a center point of the magnet 32a and a center point of the magnet 32b to each other. In other words, a distance L1 between a center of the magnet 32a and the line segment A1 is smaller than a distance L2 between the center of the magnet 32b and the line segment A1.

In such disposition, a direction of magnetic flux lies sideways in a range H1, which is closer to a reverse rotation side of the squeezing roller 50 than a closest point P10 between the squeezing roller 50 and the rotary drum 20 is. That is, the direction of the magnetic flux is a direction in which a circumferential component of the squeezing roller 50 is larger than a radial component of the squeezing roller 50. The direction of the magnetic flux stands in a range H2, which is closer to a rotation side of the squeezing roller 50 than the closest point P10 is. That is, the direction of the magnetic flux is a direction in which a radial component of the squeezing roller 50 is larger than a circumferential component of the squeezing roller 50. Since the magnetic bodies k each have a short needle shape, there is a possibility that the magnetic bodies k are stuck in an outer peripheral surface of the squeezing roller 50 and the magnetic bodies k are attached to the squeezing roller 50. However, with such a direction of the magnetic flux, the magnetic bodies k are unlikely to be stuck in the squeezing roller 50 in a direction where the magnetic bodies k lie when the magnetic bodies k go in between the squeezing roller 50 and the rotary drum 20. When the magnetic bodies k are sent out from between the squeezing roller 50 and the rotary drum 20, the magnetic bodies k are strongly pulled in a vertical direction. Therefore, the magnetic bodies k stuck in the squeezing roller 50 are easily pulled out from the squeezing roller 50. Therefore, due to such reaction, a phenomenon in which the magnetic bodies k are stuck and attached to the squeezing roller 50 can be suppressed.

The embodiment of the present invention has been described hereinbefore. However, the present invention is not limited to the embodiment. For example, the permanent magnets are given as examples of a magnet in the embodiment. However, electromagnets may be applied as the magnet. In this case, by making a current, the number of winding of a winding wire, and a size or disposition of a yoke different, the magnitude of a magnetic force exerted to the outer peripheral surface of the rotary drum can be changed. Although a configuration where the plurality of permanent magnets are arrayed with gaps is described as an example in the embodiment, the magnet may be configured by one continuous permanent magnet. A configuration where the plurality of permanent magnets are arrayed without gaps may be adopted. Although a configuration where the liquid surface L0 is set in advance is described as an example in the embodiment, a configuration where the liquid surface L0 fluctuates may be adopted. In this case, a mechanism that changes disposition of the magnet in synchronization with the fluctuations of the liquid surface L0 may be added. In addition, since the present apparatus is an apparatus that separates between a solid and a liquid, a liquid other than the coolant liquid, such as fresh water, may be used. In addition, details described in the embodiment can be changed as appropriate without departing from the concept of the invention.

It should be understood that the invention is not limited to the above-described embodiment, but may be modified into various forms on the basis of the spirit of the invention. Additionally, the modifications are included in the scope of the invention.

What is claimed is:

1. A drum type separation apparatus comprising:
a liquid passage that allows a liquid mixed with a magnetic body to pass therethrough;
a rotary drum that is disposed such that a part of the rotary drum is exposed above a liquid surface in the liquid passage, and transports the magnetic body adsorbed on an outer peripheral surface as the rotary drum rotates; and
a magnet that is disposed on an inner side of the rotary drum,
wherein a magnetic force on a side lower than the liquid surface from an intersection position where the rotary drum and the liquid surface intersect each other is larger than a magnetic force on a side higher than the liquid surface from the intersection position.

2. The drum type separation apparatus according to claim 1,
wherein the magnet includes a plurality of permanent magnets having thicknesses different from each other, and
a thickness of the permanent magnet disposed on the side higher than the intersection position is smaller than a thickness of the permanent magnet disposed on the side lower than the intersection position.

3. The drum type separation apparatus according to claim 1,
wherein the magnet includes a plurality of types of permanent magnets made of materials different from each other, and
a material for the permanent magnet disposed on the side higher than the intersection position has a magnetic force smaller than a material for the permanent magnet disposed on the side lower than the intersection position.

4. The drum type separation apparatus according to claim 1, further comprising:
a squeezing roller that separates the liquid with the magnetic body interposed between the outer peripheral surface of the rotary drum and the squeezing roller,
wherein the magnet includes a first magnet and a second magnet, which are disposed to be shifted respectively in a rotation direction and a reverse rotation direction of the rotary drum with respective to a line segment that connects a rotation center of the rotary drum and a rotation center of the squeezing roller to each other and are adjacent to each other, in a longitudinal section, and
the line segment is shifted in the rotation direction from a midpoint of a line segment that connects a center of the first magnet and a center of the second magnet to each other.
